(19) United States
(12) Patent Application Publication
(10) Pub. No.: US 2012/0316994 A1
(43) Pub. Date: Dec. 13, 2012

(54) CUSTOMIZABLE RETAIL SYSTEM WITH REVENUE SHARING

(75) Inventors: Michael P. Balter, Lake Oswego, OR (US); Ngu H. Nguyen, Lake Oswego, OR (US); Seth B. Coleman, Troutdale, OR (US)

(73) Assignee: THE PATRON COMPANY LLC, Lake Oswego, OR (US)

(21) Appl. No.: 13/158,317

(22) Filed: Jun. 10, 2011

(51) Int. Cl. G06Q 30/00; G06Q 10/00

(52) U.S. Cl. 705/26.62; 705/26.81; 705/30; 705/27.2; 705/330

(57) ABSTRACT

Disclosed are methods, processes, systems, apparatuses, and non-transitory, tangible computer-readable media for facilitating online sales of goods and services, including revenue sharing with non-profit organizations, such as schools or charities. In various embodiments, a revenue-sharing retail system facilitates an organization in proving an online retail interface through which goods or services can be purchased. In various embodiments, the online retail interface may be skinned to look and act like a website for the organization. In various embodiments, the goods or services provided for sale by the revenue-sharing retail system may be specialized goods or services which are associated with the organization, common stock items which carry no particular association, or a combination thereof. In various embodiments, the revenue-sharing retail system may share a portion of revenues received for the goods and/or services with the organization. In various embodiments, the revenue-sharing retail system may facilitate fulfillment of the goods or services.

### BACKGROUND

Many organizations that are not, by nature, retail establishments often seek to sell good or services to provide themselves a revenue stream. For example, non-profit organizations such as schools, community organizations, arts organizations, and charities may desire to have a retail presence. In some instances, the organizations may produce one or more products themselves that they wish to sell to increase funding.

However, it is difficult for organizations without technical and/or retail experience to generate this presence in a successful manner. This can be especially true if the organization wishes to have an online retail presence, as setting up online services can be difficult and time-consuming to inexperienced persons. This difficulty can be true even if the organization produces products or services which it sells in a store or in a face-to-face manner. Further, even when an organization provides its own goods and services, the organization may feel frustrated by the limitations of what it can make or provide and seek out additional retail opportunities.

### BRIEF DESCRIPTION OF THE DRAWINGS

Embodiments of the present invention will be readily understood by the following detailed description in conjunction with the accompanying drawings and flow charts. Embodiments of the invention are illustrated by way of example and not by way of limitation in the figures of the accompanying drawings.

FIG. 1 is a block diagram illustrating components of an revenue-sharing retail system as well as interactions between customers and the revenue-sharing retail system;

FIG. 2 is a block diagram interactions between a customer, an organization website, and a website interface provided by the revenue-sharing retail system;

FIG. 3 is a flowchart illustrating an exemplary process for the revenue-sharing retail system to facilitate a customer in shopping for items;

FIG. 4 is a flowchart illustrating an exemplary process for the revenue-sharing retail system to generate an online retail interface;

FIG. 5 is a flowchart illustrating an exemplary process for the revenue-sharing retail system to sell items to a customer and share revenues with an organization;

FIG. 6 is an exemplary interface provided by the revenue-sharing retail system for a customer to purchase items;

FIG. 7 is an exemplary interface provided by the revenue-sharing retail system for a customer to browse items for purchase;

FIG. 8 is an exemplary interface provided by the revenue-sharing retail system for facilitating a customer in purchasing selected items;

FIG. 9 is a flowchart illustrating an exemplary process for the revenue-sharing retail system to facilitate a customer in searching for items;

FIG. 10 is an exemplary interface provided by the revenue-sharing retail system for providing search results after a customer requests a search;

FIG. 11 is a flowchart illustrating an exemplary process for the revenue-sharing retail system to facilitate fulfillment of purchased items;

FIG. 12 is a flowchart illustrating an exemplary process for the revenue-sharing retail system to determine revenues to be shared with an organization;

FIG. 13 is a flowchart illustrating an exemplary process for the revenue-sharing retail system to provide a charity gift registry for an organization to a customer; and

FIG. 14 is a block diagram illustrating a generalized example of a computing environment on which several of the described embodiments may be implemented.

All figures are ranged in accordance with various embodiments of the present disclosure.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments or implementations of the present invention, are synonymous. The term “exemplary” is used herein merely illustrates that an example is being shown or described and is not intended to denote that any so-described feature is preferred or required over any other. Additionally, while flowcharts and descriptions of processes may make reference to particular steps, it should be understood that, in alternative implementations, the illustrated steps may be combined or divided into two or more sub-steps.

Various embodiments are directed to computer-implemented methods, processes, systems, apparatuses, and non-transitory, tangible computer-readable media for facilitating online sales of goods and services, including revenue sharing with non-profit organizations, such as schools or charities. In various embodiments, a revenue-sharing retail system facilitates an organization in proving an online retail interface through which goods or services can be purchased. In various embodiments, the online retail interface may be skinned to look and act like a website for the organization. This customization of the interface may provide for a more seamless experience for visitors to the organization's website, and may engender trust on the part of a customer/visitor to the site. In various embodiments, the online retail interface may provide advertising which is selected at least in part based on the identity of the organization.

In various embodiments, the goods or services provided for sale by the revenue-sharing retail system may be specialized goods or services which are associated with the organization, common stock items which carry no particular association, or a combination thereof. In various embodiments, the specialized items may be sold through a separate portion of the online retail interface than the common stock items. In various embodiments, the common stock and specialized items may be searchable by a customer with a single search. In various embodiments, items may be fulfilled and shipped to a customer by the revenue-sharing retail system, one or more distributors, and/or by the organization itself.

In various embodiments, the revenue-sharing retail system may share a portion of revenues received for the goods and/or services with the organization. In various embodiments, the revenue-sharing retail system may thus be able to provide the organization with additional revenue streams. In various embodiments, particular amounts or percentages of revenue to be shared may change based on factors such as whether the item is specialized or from common stock, how much profit is expected to be received from sale of the item, or other factors. In other embodiments, the organization may also set up a registry of needed items for interested customers to purchase for the organization; after purchase, these items may be delivered to the organization rather than to the customer purchasing the items.

While some embodiments described herein are focused on the offering and purchase of “items,” in various embodiments, various goods and/or services may be offered for sale using the techniques and systems described herein. For example, in various embodiments, tickets to events may be sold using the revenue-sharing retail system. It may be recognized that the descriptions offered herein with respect to describing, selling, and/or shipping of items may be applied, as applicable to various goods or services without limiting the scope of embodiments herein.

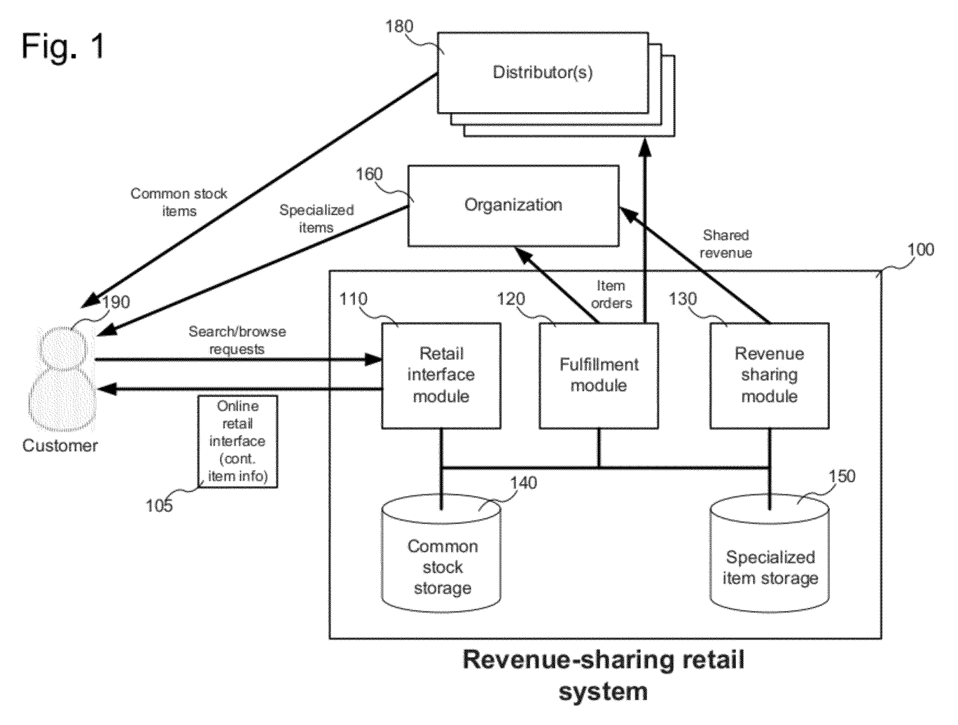

FIG. 1 is a block diagram illustrating components of a revenue-sharing retail system 100, as well as information flows between the revenue-sharing retail system 100 and a customer 190 and an organization 160. In various embodiments, the revenue-sharing retail system 100 may act to sell items to the customer 190 in order to provide shares of revenue received from the customer 190 to the organization 160. As discussed above, in various embodiments, the organization 190 may comprise one of various groups or associations, such as non-profit organizations, charities, sports teams, religious groups, advocacy groups, arts organizations, etc. In various embodiments, the revenue-sharing retail system 100 may also interact with one or more distributor(s) 180.

While the example of FIG. 1 illustrates particular modules, storage units, and other entities, in various embodiments the revenue-sharing retail system 100 may omit one or more of these elements, may combine illustrated elements and/or may comprise additional elements which are not illustrated. Additionally, while particular examples of a customer 190, an organization 160, and distributor(s) 180 are illustrated, in various embodiments the revenue-sharing retail system 100 may interact with various and/or multiple customers, organizations, distributors and/or interfaces.

As illustrated, the revenue-sharing retail system 100 comprises common stock storage 140 and specialized item storage 150. In various embodiments, the common stock storage 140 and specialized item storage 150 may comprise various forms of data storage, including hard drives, solid state drives, and removable and/or magnetic media. Additionally, in various embodiments, the data stored on the common stock storage 140 and specialized item storage 150 may be maintained in various formats, including, for example, as a database or in one or more separate files.

In various embodiments, the common stock storage 140 is configured to store information about one or more common stock items for which may be offered for sale by the revenue-sharing retail system 100. In various embodiments, the common stock items for which information is stored on the common stock storage 140 may be offered for sale by the revenue-sharing retail system 100 in association with multiple organizations.

In various embodiments, the specialized item storage 150 is configured to store information about one or more specialized items for which may be offered for sale by the revenue-sharing retail system 100. In various embodiments, the specialized items for which information is stored on the specialized item storage 140 may be specifically associated with the organization. In various embodiments, the specialized items may be provided and/or selected by the organization itself to be offered for sale. For example, specialized items may include goods that are branded or colored to match the organization's look, such as a sport jersey with the logo of a team associated with a school.

In various embodiments, the revenue-sharing retail system 100 may comprise various modules which interact internally in the revenue-sharing retail system 100 as well as externally to the system. In various embodiments, the revenue-sharing retail system 100 may comprise a retail interface module 110 which may be configured to interact with the customer 190 in order to generate and provide an online retail interface 105 through which the customer can purchase items. For example, as illustrated, the retail interface module 110 may provide the online retail interface 105 to the customer, such as in response to a request by the customer to view the organization's online retail presences. Additionally, in various embodiments, the retail interface module 110 may be configured to generate the online retail interface 105 to look like interfaces or other web-based presences that the organization 160 may provide. Additionally, in various embodiments, the retail interface module 110 may be configured to display advertising as part of the online retail interface 105 which is thematically appropriate or otherwise associated with the organization 160.

In various embodiments, the retail interface may also interact with the fulfillment module 120 and the revenue sharing module 130 in order to provide information about which items were purchased so that the fulfillment module 120 and the revenue sharing module 130 may perform their actions. In various embodiments, and as described herein, the online retail interface 105 provided by the retail interface module 110 may comprise a web page, though in other embodiments, other interfaces may be provided, such as through web services or APIs.

In various embodiments, the online retail interface 105 generated and provided by the retail interface module 110 may provide the customer 190 with one or more facilities for browsing and/or searching inventory of the revenue-sharing retail system 100. As will be described in greater detail below, the customer 190 may make requests for browsing or searching the inventory to the retail interface module 110, and may receive item information in return.

In various embodiments, the revenue-sharing retail system 100 may additionally comprise a fulfillment module 120 which may be configured to interact with the organization 160 and/or one or more distributor(s) 180 in order to identify one or more items to be shipped after a purchase is completed with the customer. For example, if a customer buys one or more items from the common stock of items, the fulfillment module 120 may send one or more item orders to one or more distributors out of the distributors 180 requesting the distributors ship the purchased items to the customer. In another embodiment, if a customer buys one or more specialized items, the fulfillment module 180 may send one or more item orders to the organization 160 requesting the organization 160 ship the purchased items to the customer. In various embodiments, the fulfillment module 120 may operate by sending notifications to the organization and/or distributor(s) 180; in alternative embodiments, the fulfillment module 120 may provide an interface through which the organization and/or distributor(s) 180 may view and/or track shipments which need to be made.

In various embodiments, the revenue-sharing retail system 100 may additionally comprise a revenue sharing module 130 which may be configured to determine an amount of shared revenue to transmit to the organization after purchases have been made through the revenue-sharing retail system 100. In various embodiments, as described herein, the revenue sharing module 130 may determine amounts of revenue to share based on factors such as: amount of profit margin, whether the item is a specialized item or a common stock item, or other factors.

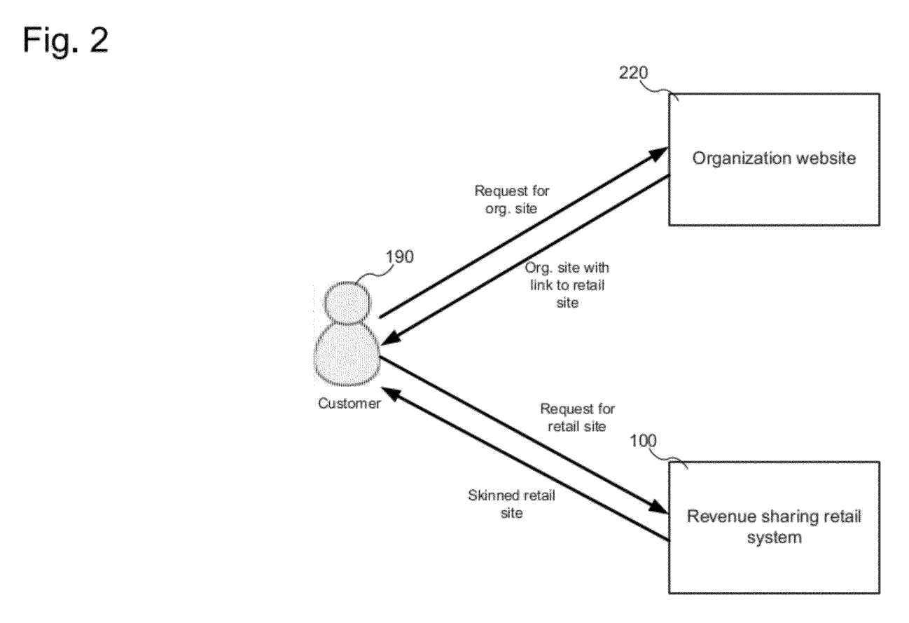

FIG. 2 is a block diagram illustrating interactions between a customer 190, an organization website 220, such as for the organization 160, and the revenue-sharing retail system 100. As discussed herein, in various embodiments, the revenue-sharing retail system 100 may generate the online retail interface 105 using the retail interface module 110 in order to provide the customer with an interface through which to purchase items. As the example of FIG. 2 shows, the customer 190 may make a request to the organization website to view a retail website. In some embodiments, the customer may request the retail website to purchase branded or themed items relating to the organization. In other embodiments, the customer may request to visit the retail website to provide support to the organization, such as in the form of the shared revenue or purchases from a charitable gift registration, as described herein.

In some embodiments, the request may be to visit a sub-domain of the organization website 220, so that the retail interface is integrated into the domain of the organization. For example, for an organization called Friends of the Old Outback, with a website www.foo.org, the customer may elect to go to store.foo.org to visit the online retail presence of the FOO organization. The customer may type this URL in directly or may be suggested to go to the URL, such as by a link provided by the organization website, as illustrated. In alternative embodiments, the customer may be directed, such as by a link, to go to an online retail interface which is held outside of the organization website. In some embodiments the organization website or the revenue-sharing retail system 100 may utilize redirects to help place the customer at the correct webpage.

In either event the customer may then send a request to the revenue-sharing retail system 100 to view the online retail interface 105. In various embodiments, the revenue-sharing retail system 100 may then, using the retail interface module 110, produce an online retail interface 105 and send the interface to the customer. In various, embodiments, the online retail interface 105 may be skinned to conform to the look and feel of the organization website, as described herein. In various embodiments, by leading the customer from the organization website 220 to an interface provided by the revenue-sharing retail system 100, the revenue-sharing retail system 100 may provide a greater deal of comfort with the shopping and donation experience the customer has, since the online retail interface 105 will retain a level of familiarity based on the look and feel of the organization website.

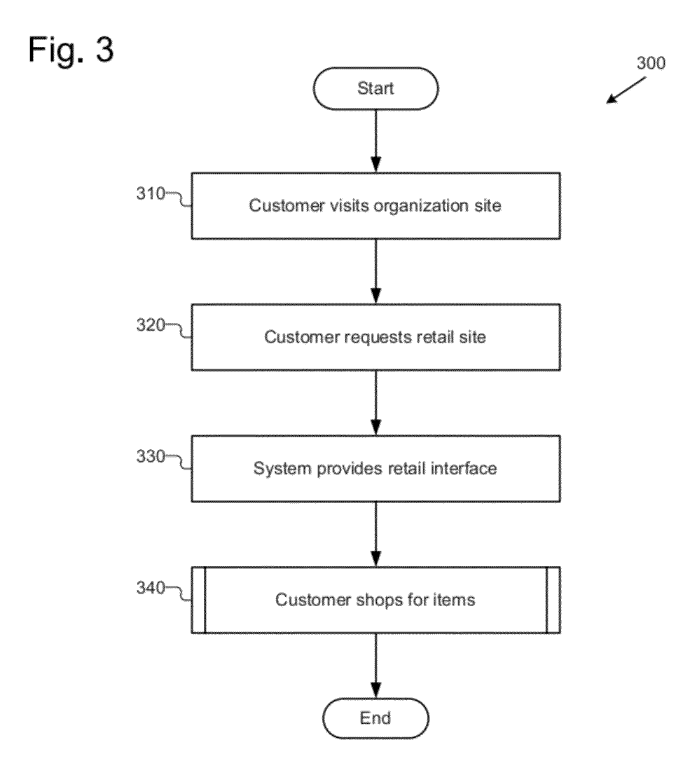

FIG. 3 is a flowchart illustrating an exemplary process 300 for the revenue-sharing retail system 100 to facilitate a customer in shopping for items. In various embodiments, one or more of the operations illustrated in FIG. 3 may be combined, split into multiple operations, or omitted altogether. The process may begin at operation 310 where the customer may visit the site of an organization he or she is interested in. At operation 320, the customer may request to visit a retail website associated with the organization. Examples of such requests were described above. Next, at operation 330, the revenue-sharing retail system 100 may provide an online retail interface 105 in response to the received request and provide this interface to the customer. Finally, at operation 340, the customer may shop for items to purchase. Particular embodiments of operation 340 are described below. The process may then end.

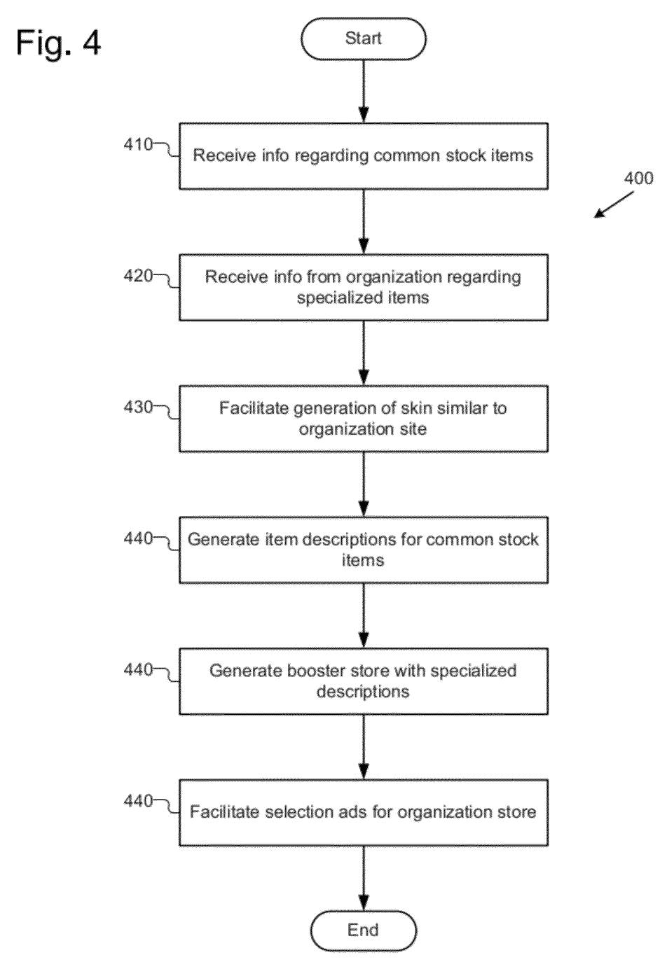

FIG. 4 is a flowchart illustrating an exemplary process 400 for the for the revenue-sharing retail system 100 to facilitate generation of an online retail interface 105. In various embodiments, one or more of the operations illustrated in FIG. 4 may be combined, split into multiple operations, or omitted altogether. In various embodiments, the operations of process 400 may be performed prior to a request for the online retail interface 105 by the customer; in other embodiments, one or more of the operations may be performed contemporaneously with or after the request is made. In various embodiments, one or more operations of process 400 may be performed by the retail generation module 110. The process may begin at operation 410, where the revenue-sharing retail system 100 may receive information regarding common stock items. In various embodiments, this information may comprise one or more of: descriptive information about items, item photos, pricing information, shipping information, and/or other information. In various embodiments, some or all of the information may be received from entities which provide and/or ship the common stock items, such as the distributor(s) 180. Next, at operation 420, the revenue-sharing retail system 100 may receive information regarding specialized items. In various embodiments, some or all of the information may be received from the organization 160, which may create or otherwise provide the specialized items.

At operation 430, the revenue-sharing retail system 100 may facilitate generation of one or more skins for the online retail interface 105. As described herein, these skins may, in various embodiments, be generated to incorporate a look and feel which is substantially similar to the look and feel of the organization's website. In various embodiments, the revenue-sharing retail system 100 may comprise one or more modules for designing and/or coding the skin. In other embodiments, the revenue-sharing retail system 100 may provide an interface for receiving a skin that has been designed elsewhere.

At operation 440, the retail interface module 110 may then generate item descriptions for the common stock items that will be sold through the online retail interface 105. In various embodiments, the item descriptions may include textual and/or image information received at operation 420. At operation 450, the retail interface module 110 may generate an area for selling of specialized items, including item descriptions for the specialized items. In various embodiments, the are may be referred to as a “booster store” or another appellation. In various embodiments, the item descriptions of the specialized items in the booster store may include textual and/or image information received at operation 430.

At operation 430, the retail interface module 110 may facilitate selection of advertisements to be shown to customers who visit the online retail interface 105. In various embodiments, ads may be selected to be harmonious with the organization's website and/or the online retail interface 105. In various embodiments, selection of ads may be performed using 3rd party advertising services, such as through the submission of keywords or other information. In various embodiments, the information used for selection may be taken from item information, such as that received at operations 410 and 420. In various embodiments, the ads selected may comprise textual ads, image ads, video ads, or combinations thereof. In some embodiments, selection of ads may be performed contemporaneously with a customer request for the online retail interface 105, or with a request to seek particular information through the interface. In some such environments, the customer's identity or other information about the customer, such as information kept in cookies, may be used to select ads. The process may then end.

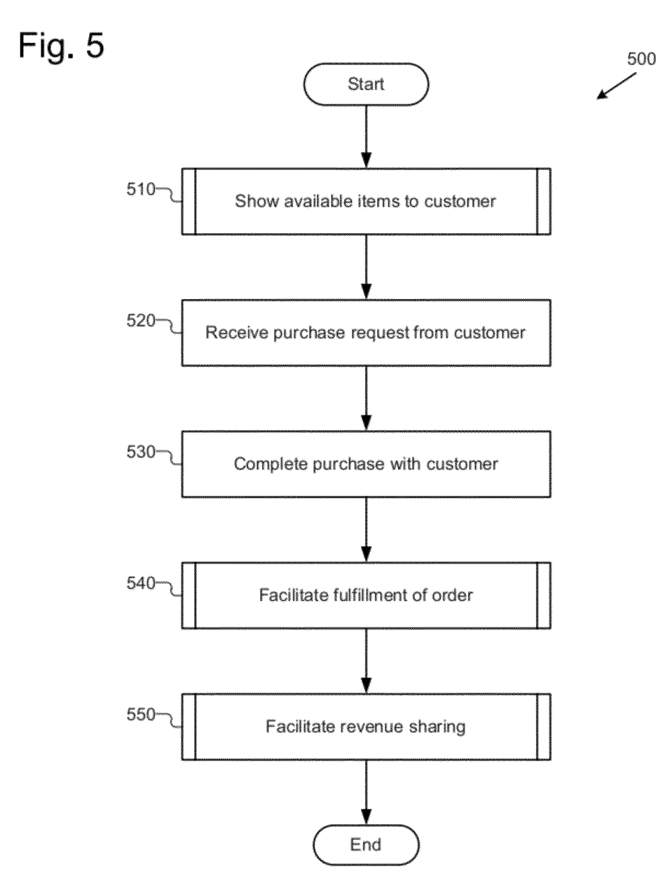

FIG. 5 is a flowchart illustrating an exemplary process 500 for the revenue-sharing retail system 100 to sell items to a customer and share revenues with an organization. In various embodiments, one or more of the operations illustrated in FIG. 5 may be combined, split into multiple operations, or omitted altogether. In various embodiments, process 500 may implement operation 340 of FIG. 3. The process may begin at operation 510, where the revenue-sharing retail system 100 may show items to a customer, such as through the online retail interface 105 provided by the retail interface module 110. Particular examples of embodiments of operation 510 are described below.

Next, at operation 520, the revenue-sharing retail system 100 may receive a purchase request from the customer 190. As will be understood, purchase requests may be received in many forms in accordance with known electronic commerce practices. Thus, the customer 190 may indicate items that he or she wishes to buy in a piecemeal fashion, as he or she customer browses through multiple items. Alternatively, the customer 190 may select many items at once for purchase or may select a single item. At operation 530, the revenue-sharing retail system 100 may then complete the purchase with the customer 190. Again, the completion of the purchase, including a selection of payment method, conduct of transaction, and receipt of payment from the customer, may be performed in various embodiments as will be understood.

At operation 540, the revenue-sharing retail system 100 may facilitate fulfillment of the order. For example, the revenue-sharing retail system 100 may facilitate the organization 160 and/or the various distributor(s) 180 in fulfilling and shipping items to the customer. In other embodiments, operation 540 may comprise the revenue-sharing retail system 100 facilitating the shipment of one or more items to the organization, such as when a charity gift registry is used. Particular examples of embodiments of operation 540 are described below. At operation 550, the revenue-sharing retail system 100 may facilitate revenue sharing with the organization, such as by determining an amount of revenue to be shared with the organization 190, as well as facilitating transmission of the shared revenue to the organization. Particular examples of embodiments of operation 540 are described below. The process may then end.

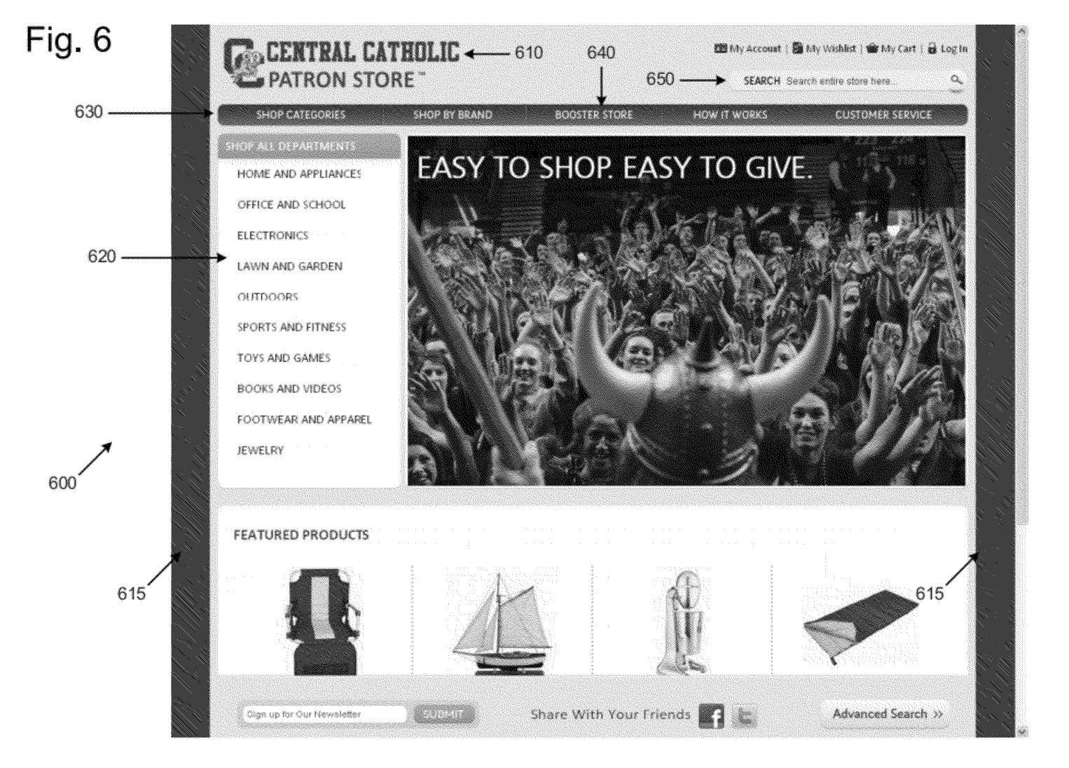

FIG. 6 illustrates one example of an implementation 600 of the online retail interface 105 for facilitating a customer to purchase items. While the interface example of FIG. 6 illustrates particular graphical elements and offers particular interactions to a user, it will be recognized that, in various embodiments, different interfaces may include different graphical and/or interactive configurations. As illustrated in FIG. 6, in various embodiments, the online retail interface 105 may prominently display an affiliation with an organization 160; in the example of FIG. 6, the organization 160 is Central Catholic High School. Additionally, the online retail interface 105 may utilize colors or other branding associated with the organization 160, such as the color bands 615, and the use of the same color in the navigation bar 630.

In various embodiments, the online retail interface 105 may provide various navigation elements for use by a customer during shopping, such as the navigation bar 630 and a browsing categories element 620. In various embodiments, these navigation elements may facilitate a customer 190 in obtaining information about items and selecting those items for purchase. In particular, it may be noticed that the navigation bar 630 contains a “Booster Store” element 640. In various embodiments, the Booster Store element may navigate a customer 190 to a particular sub-portion of the online retail interface 105, where he or she can review and purchase specialized items which are associated with the organization 190. Finally, the online retail interface 105 may also contain a search element 650. Particular embodiments of use of browsing and search of items are described herein.

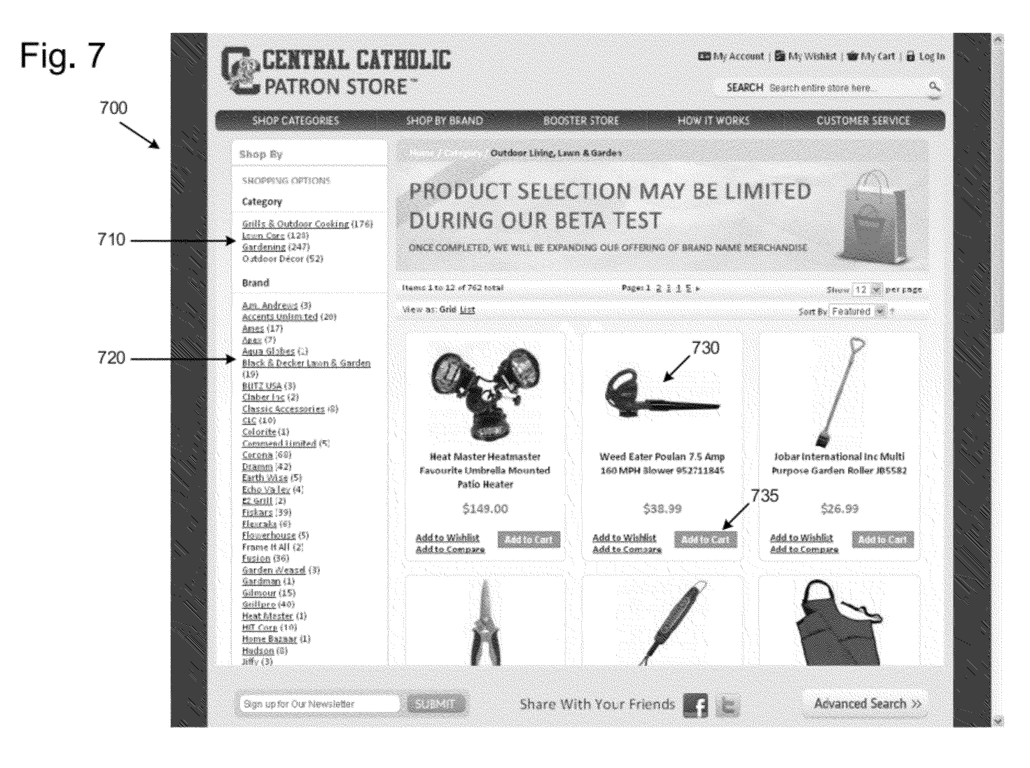

FIG. 7 illustrates one example of an implementation 700 of the online retail interface 105 for facilitating a customer to browse items for purchase. While the interface example of FIG. 7 illustrates particular graphical elements and offers particular interactions to a user, it will be recognized that, in various embodiments, different interfaces may include different graphical and/or interactive configurations. In various embodiments, interface implementation 700 may be seen by a customer 190 after the customer has selected a category for browsing, such as a category from the categories element 620 of interface implementation 600. In the example of FIG. 7, the interface may be reached by selecting the “Lawn and Garden” category illustrated in FIG. 6.

As illustrated in FIG. 7, in various embodiments, the online retail interface 105 may contain one or more sub-categories elements 710 to further specify a browsing experience for a customer 190. In various embodiments, the online retail interface 105 may contain one or more brand elements 720, which also may serve to further specify a browsing experience for a customer 190. As illustrated, the online retail interface 105 may also comprise one or more item descriptions of items available for purchase, such as item description 730. In various embodiments, the item description 730 may comprise various pieces of information about an item, such as a textual description, an image description, and/or price. In other embodiments, the item description 730 may contain information such as the distributor, whether the item is a specialized item provided from the organization 160 itself, an indication of the amount of revenue that may be shared with the organization 160, or other information. In various embodiments, the item description 730 may comprise navigation and/or purchase elements as will be understood, such as, for example, an “Add to cart” element 735.

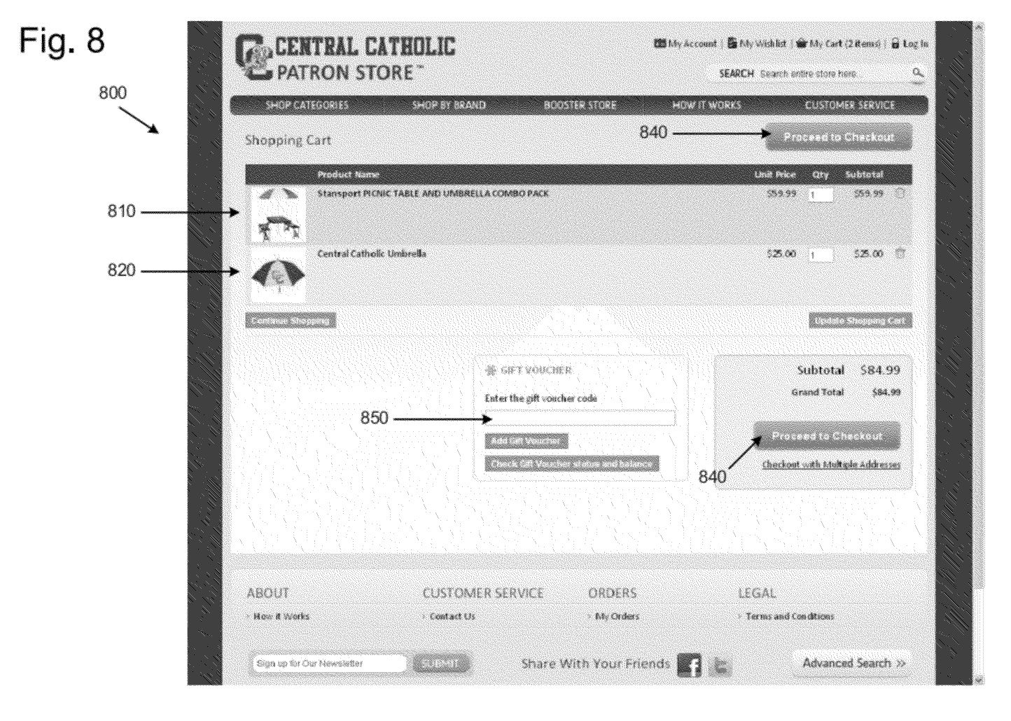

FIG. 8 illustrates one example of an implementation 800 of the online retail interface 105 for facilitating the customer 190 in purchasing selected items. While the interface example of FIG. 8 illustrates particular graphical elements and offers particular interactions to a user, it will be recognized that, in various embodiments, different interfaces may include different graphical and/or interactive configurations. In various embodiments, interface implementation 800 may be seen by a customer 190 after the customer has selected an item, such as by selecting the “Add to cart” element 735 of FIG. 7.

As illustrated in FIG. 8, in various embodiments, the retail interface module 110 may provide an online retail interface 105 which displays a shopping cart of items selected by the customer 190. In various embodiments, and as will be understood, the shopping cart may be structured an presented to the user in various forms and with various features. For example, the interface 105 may present checkout elements 840, which allow the customer to purchase the items in the shopping cart, as will be understood. Additionally, in various embodiments, a gift certificate or gift voucher element 850 may be displayed to provide discounts for customers.

In particular, and as illustrated in FIG. 8, a shopping cart may contain both common stock items, such as the picnic table and umbrella combo pack 810, as well as specialized items, such as the Central Catholic umbrella 820. Thus, as the example shown, both common stock and specialized items can be mixed, in various embodiments, as a customer 190 purchases items through the revenue-sharing retail system 100.

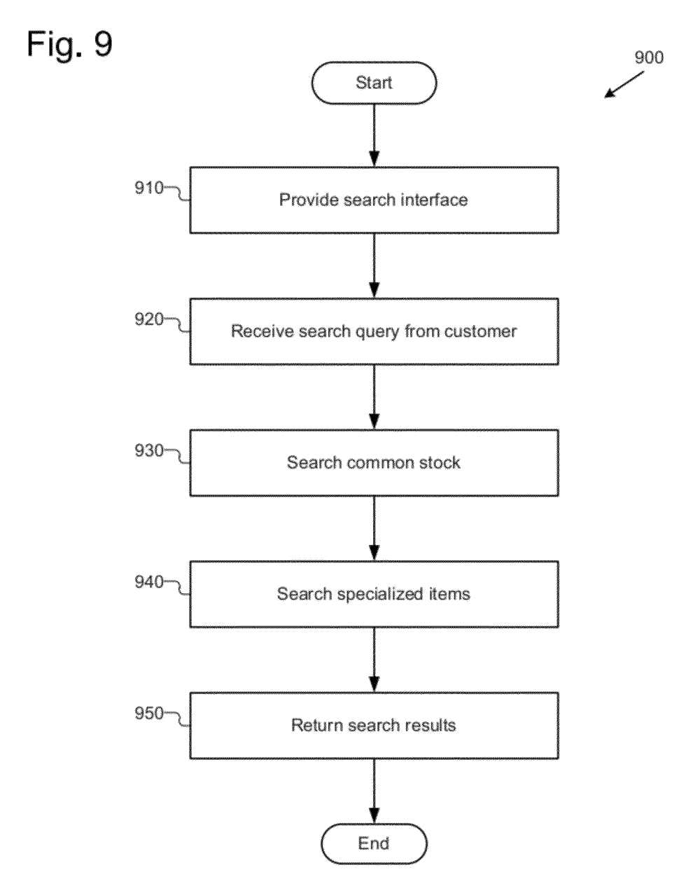

FIG. 9 is a flowchart illustrating an exemplary process 900 for the revenue-sharing retail system 100 to facilitate a customer 190 in searching for items. In various embodiments, one or more of the operations illustrated in FIG. 9 may be combined, split into multiple operations, or omitted altogether. In various embodiments, process 900 may implement operation 510 of FIG. 5. In various embodiments, the process of FIG. 9 may allow a customer 190 to search for items from both common stock and from specialized items associated with the organization. This combined searching allows the customer a higher degree of freedom than if he or she were to simply browse between common stock and specialized items, and may helps ensure that neither type of item is presented to the detriment of the other.

The process may begin at operation 910, where, in various embodiments, the retail interface module 110 provides a search interface to the customer 190, such as, for example in an online retail interface 105. One example of such a search interface was seen above at search element 650 of FIG. 6. At operation 920, in various embodiments, the retail interface module 110 may receive a search query from the customer 190. For example, the retail interface module 110 may receive one or more keywords describing items the customer 190 is interested in reviewing. In various embodiments, at operation 930, the retail interface module 110 may search the common stock for items that are related to the search query. This may be performed, in various embodiments, by searching information stored on the common stock storage 140. In various embodiments, at operation 940, the retail interface module 110 may search for specialized items that are related to the search query. This may be performed, in various embodiments, by searching information stored on the specialized item storage 150. Finally, at operation 950, the retail interface module 110 may return search results based on the search query. As discussed above, these returned results may contain both common stock and specialized items.

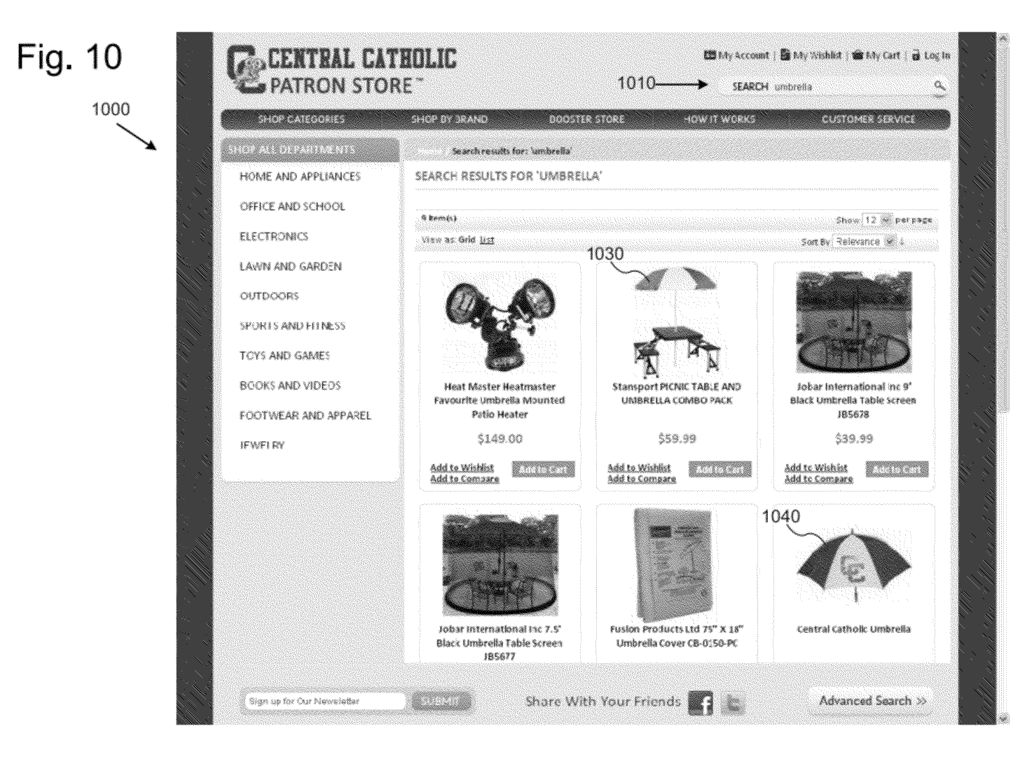

FIG. 10 illustrates one example of an implementation 1000 of the online retail interface 105 for providing search results after a customer 190 requests a search. While the interface example of FIG. 10 illustrates particular graphical elements and offers particular interactions to a user, it will be recognized that, in various embodiments, different interfaces may include different graphical and/or interactive configurations. In various embodiments, interface implementation 1000 may be seen by a customer 190 after the customer has submitted a search query, such as through the process of FIG. 9, using the search element 650.

In various embodiments, the online retail interface 105 may present the search query back to the customer in the search element, such as in example search element 1010. In the example, a customer has entered the search query “umbrella.” As noted in the discussion above with respect to the process of FIG. 9, the revenue-sharing retail system 100 may then, in various embodiments, search through both its common stock and specialized items for results relating to “umbrella.” Thus, in the example of FIG. 10, the online retail interface 105 has returned both a common-stock “picnic table and umbrella combo pack,” as shown in item description 1030, and a “Central Catholic umbrella,” as shown in item description 1040. It may be noted that both of these items may be added to a shopping cart, as illustrated above at FIG. 8.

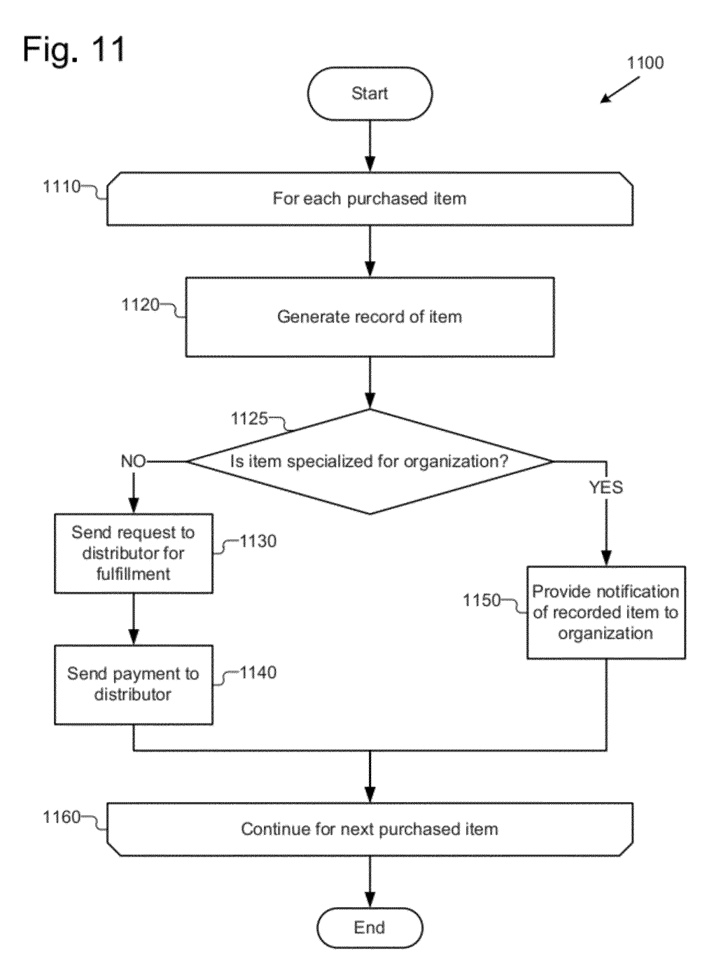

FIG. 11 is a flowchart illustrating an exemplary process 1100 for the revenue-sharing retail system 100 to facilitate fulfillment of purchased items by a customer 190. In various embodiments, the operations of process 1100 may be performed by the fulfillment module 120. In various embodiments, one or more of the operations illustrated in FIG. 11 may be combined, split into multiple operations, or omitted altogether. In various embodiments, process 1100 may implement operation 540 of FIG. 5. In various embodiments, process 1100 may be performed to facilitate shipment of items from disparate locations to a customer. For example, if a customer orders multiple common stock items, those common stock items may be provided by multiple distributors 180, who may ship the items to the customer 190 separately. In another example, the customer orders a specialized item, that item may be provided by the organization 160 itself. In such a case, the revenue-sharing retail system 100 may need to inform the organization 160 that the item must be shipped to the customer 190.

The process may begin at loop operation 1110, where, in various embodiments, a loop is begun for each item purchased by the customer. Within the loop, at operation 1120, the fulfillment module 120 may generate a record of the item. In various embodiments, the record may contain information such as, but not limited to: an item identifier, customer name, customer address, and/or special shipping instructions. Next, at decision operation 1125, the fulfillment module 120 may, in various embodiments, determine if the item is a specialized item. If the item is not a specialized item, then at operation 1130, the a request may be sent to a distributor to fulfill the order for the purchased item. Next, at operation 1140, the fulfillment module may send payment for the purchased item to the distributor. In various embodiments, if more than one item is ordered from a distributor one or more requests and/or payments may be sent grouped together.

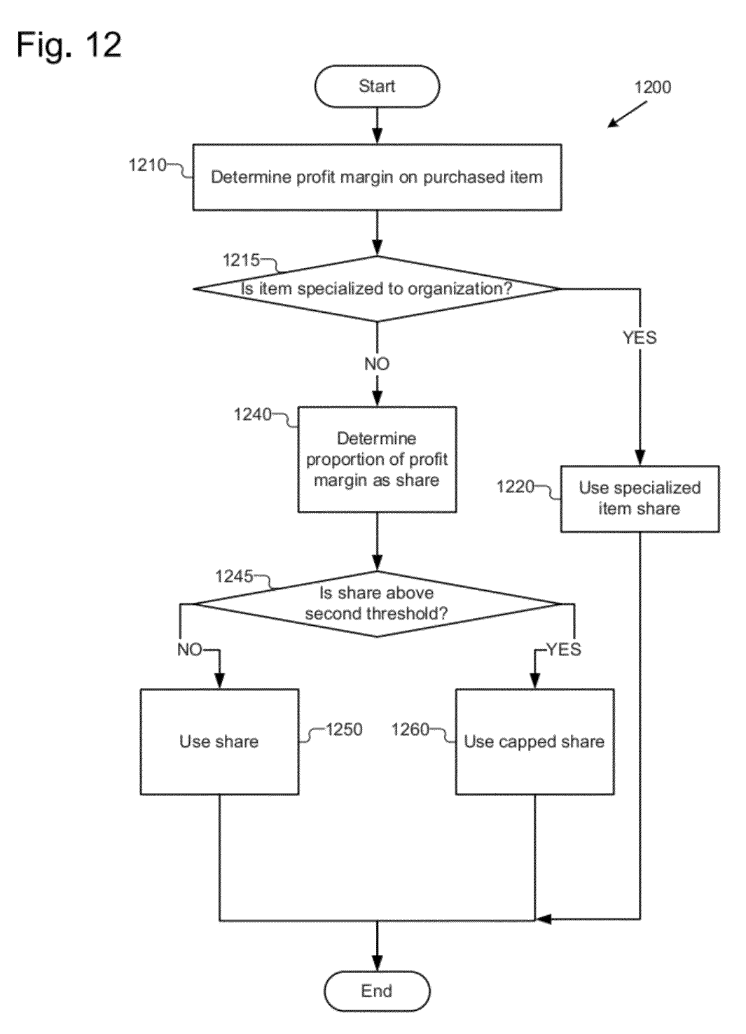

If, at decision operation 1125, the item is determined to be a specialized item, then at operation 1150 the fulfillment module may provide a notification of the recorded item to the organization for fulfillment. In one embodiment, this notification may be provided by sending of a message to a designated person at the organization 160. In another embodiment, notification may be provided by providing an interface where a person from the organization can visit and see notifications of each of the items which need fulfillment. In various embodiments, no payment may be made to the organization during process 1100, as revenue is shared with the organization during the process of FIG. 12. Finally, at operation 1160, the loop may be repeated for a next purchased item.

FIG. 12 is a flowchart illustrating an exemplary process 1200 for the revenue-sharing retail system 100 to determine revenues to be shared with an organization 160. In various embodiments, one or more of the operations illustrated in FIG. 12 may be combined, split into multiple operations, or omitted altogether. In various embodiments, process 1200 may implement operation 550 of FIG. 5. Various embodiments of process 1200 may be performed by the revenue sharing module 130. While the process illustrated in FIG. 12 is described with reference to a single item, in various embodiments, the process may be repeated for multiple purchased items before revenue is shared with an organization.

In various embodiments, the revenue sharing module 130 may determine different amounts of revenue to be shared for different items. For example, for an item with a given profit margin, the a fixed percentage (e.g. 50%) of that profit margin may be shared with the organization 160. However, for items which exceed a pre-set profit margin threshold (e.g. 10%), the revenue shared may be capped. Similarly, for items which have a profit margin below a different pre-determined threshold, no revenue may be shared, so that the revenue-sharing retail system 100 may cover costs. In some embodiments, if an item is a specialized item that is fulfilled by the organization 160, the revenue share may be different than the share used for items fulfilled by distributors. For example, for a specialized, organization-fulfilled item, the organization may receive 90% of the revenue for the item. It may be noted that, while the process of FIG. 12 does not explicitly describe the transmission of determined revenue shares to the organization, in various embodiments, the revenue sharing module 130 may transmit, or cause to be transmitted, shared revenues to the organization 160.

The process may begin at operation 1210, where the revenue sharing module 130 may determine a profit margin on the purchased item. In various embodiments, the profit margin may be known to the revenue sharing module 130 prior to purchase of the item; such information may be stored, for example in the common stock storage 140 or the specialized item storage 150. Next, at decision operation 1215, the revenue sharing module 130 may determine if the item is specialized for the organization 160. If so, then at operation 1220, the revenue sharing module 130 may use a specialized item share of revenue for the item, such as 90%.

If, however, the item is determined not to be specialized at decision operation 1215, then at operation 1240 the revenue sharing module 130 may determine a proportion of the profit margin to share with the organization 160. In various embodiments, this proportion may be pre-determined and fixed for a particular organization. In various embodiments, the proportion may be different for different organizations or for different types of items. In one example, the proportion may be 50% of the profit margin. In various embodiments, a determination may also be made as to whether the profit margin is above a minimum profit threshold; if it is, then no share may be given for the item.

Next, at decision operation 1245, the revenue sharing module 130 may determine if the determined share to be given is above a capping threshold. For example, the revenue sharing module 130 may cap the proportion at a maximum of 10% of the revenue received for the item. Thus, even if the item has a 25% profit margin and the revenue sharing module would normally provide 50% of the margin to the organization, it may still be configured to cap the share at 10%. Thus, if the share is above the capping threshold, then at operation 1260 the share may be capped. If the share is not above the capping threshold, then at operation 1250, the share will be used without modification.

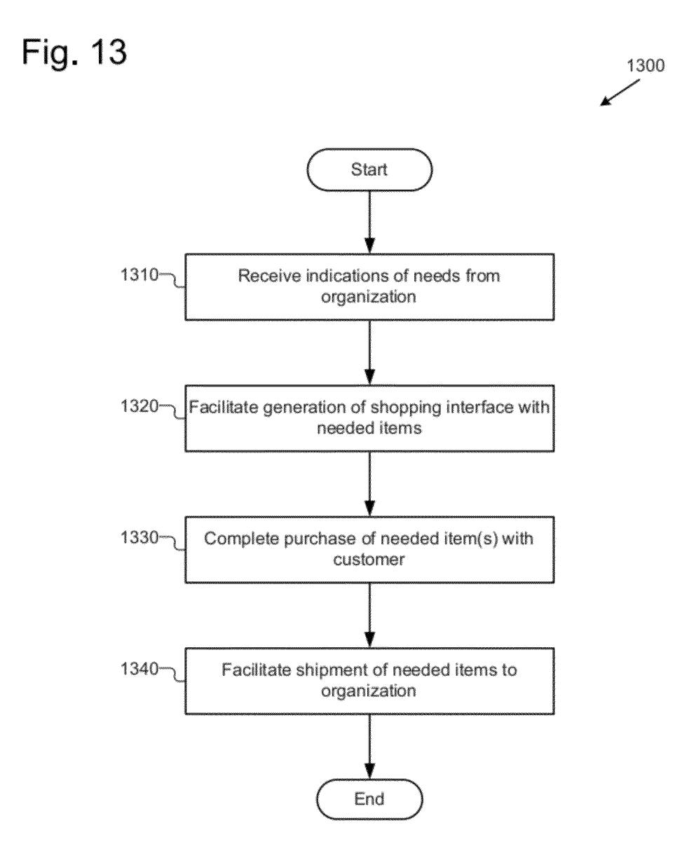

FIG. 13 is a flowchart illustrating an exemplary process 1300 for the revenue-sharing retail system 100 to provide a charity gift registry for an organization 160 to a customer. In various embodiments, one or more of the operations illustrated in FIG. 13 may be combined, split into multiple operations, or omitted altogether. In various embodiments, process 1200 may operate in concert with processes described above. While the process illustrated in FIG. 13 is described with reference to a single item, in various embodiments, the process may be repeated for multiple purchased items before revenue is shared with an organization.

In various embodiments, process 1300 may be performed in order for customers to further help an organization, such as by buying items the organization has identified particular needs for. For example, a charity which helps out school children may identify a need for 500 backpacks for area children. If a customer wishes, he may use the revenue-sharing retail system 100 to purchase one or more backpacks, with the understanding that the purchased items will go to the organization, or to other places where they are needed, rather than being delivered to the customer.

The process may begin at operation 1310, where the revenue-sharing retail system 100 receives indications of needs from the organization 160. In various embodiments, the organization 160 may select particular items from the common stock or specialized items that are needed. In other embodiments, the organization may identify a type or category of item. Next, at operation 1320, the retail interface module 110 may facilitate generation of a shopping interface that displays these needed items. For example, a special “charity registry” portion of an online retail interface 105 may be provided which lists the organization's current needs. Next, at operation 1330, the revenue-sharing retail system 100 may complete a purchase of one or more needed items with a customer 190. In various embodiments, the purchase may be performed using various techniques described herein, including searching and browsing through common stock and specialized items and using known online retail techniques. Finally, at operation 1340, the fulfillment module 120 may facilitate shipment of the needed items, such as to the organization. In some embodiments, the fulfillment module may facilitate shipment of needed items to other locations indicated by the organization. For example, the organization 160 may provide a list of schools to which backpacks should be delivered; the fulfillment module 120 may then cause backpacks to be shipped to various schools on the list. The process may then end.

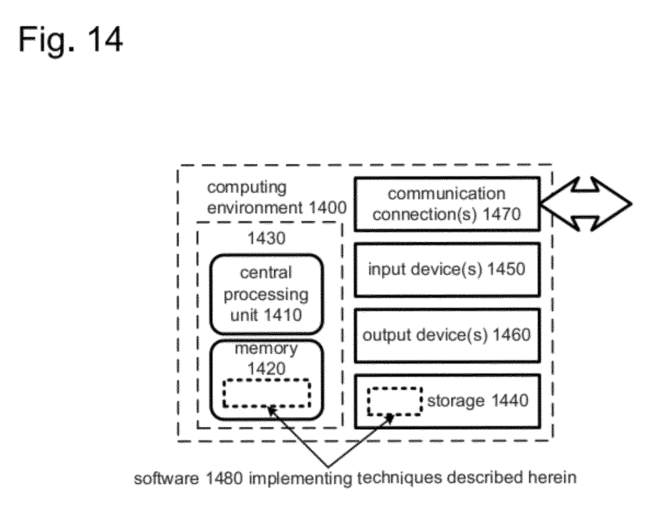

FIG. 14 illustrates a generalized example of a suitable computing environment (1400) in which several of the described embodiments may be implemented. The computing environment (1400) is not intended to suggest any limitation as to scope of use or functionality, as the techniques and tools may be implemented in diverse general-purpose or special-purpose computing environments such as personal computers, consumer electronic devices, and the like.

With reference to FIG. 14, the computing environment (1400) includes at least one CPU (1410) and associated memory (1420). In FIG. 14, this most basic configuration (1430) is included within a dashed line. The processing unit (1410) executes computer-executable instructions and may be a real or a virtual processor. In a multi-processing system, multiple processing units execute computer-executable instructions to increase processing power. The memory (1420) may be volatile memory (e.g., registers, cache, RAM), non-volatile memory (e.g., ROM, EEPROM, flash memory, etc.), or some combination of the two. The memory (1420) stores software (1480) implementing the techniques described herein.

A computing environment may have additional features. For example, the computing environment (1400) includes storage (1440), one or more input devices (1450), one or more output devices (1460), and one or more communication connections (1470). An interconnection mechanism (not shown) such as a bus, controller, or network interconnects the components of the computing environment (1400). Typically, operating system software (not shown) provides an operating environment for other software executing in the computing environment (1400), and coordinates activities of the components of the computing environment (1400).

The storage (1440) may be removable or non-removable, and includes magnetic disks, magnetic tapes or cassettes, CD-ROMs, DVDs, flash drives, disk arrays, or any other medium which can be used to store information and which can be accessed within the computing environment (1400). The storage (1440) stores instructions for the software.

The input device(s) (1450) may be a touch input device such as a keyboard, mouse, pen, or trackball, a voice input device, a scanning device, or another device that provides input to the computing environment (1400). For audio or video encoding, the input device(s) (1450) may be a sound card, video card, TV tuner card, or similar device that accepts audio or video input in analog or digital form, or a CD- or DVD-based drive that reads audio or video samples into the computing environment (1400). The output device(s) (1760) may be a display (e.g., monitor, display screen, or the like), printer, speaker, DVD-writer, or another device that provides output from the computing environment (1400).

The communication connection(s) (1470) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of non-transitory computer-readable media. Computer-readable media are any available media that can be accessed within a computing environment. By way of example, and not limitation, with the computing environment (1400), computer-readable media include memory (1420), computer-readable storage media (1440) (e.g., CDs, DVDs, diskettes, flash drives, removable hard drives, hard drive arrays), and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “determine,” “search,” and “request” to describe computer operations in a computing environment. These terms are high-level abstractions for operations performed by a computer, and should not be confused with acts performed by a human being. The actual computer operations corresponding to these terms vary depending on implementation.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A computer-implemented method for facilitating online retail sales, the method comprising:
generating, by a computing device, an online retail interface associated with an organization, the interface displaying items available for purchase, the displayed items comprising both specialized items associated with the organization and common stock items which may be displayed in interfaces associated with other organizations;
receiving, by the computing device, an order to purchase one or more of the displayed items;
receiving, by the computing device, payment for the one or more purchased items; and
determining, by the computing device, portions of payments made for each of the purchased items to be sent to the organization, the pre-determined portions of the payment including portions of payments for common stock items as well as portions of payment for specialized items.

2. The method of claim 1, further comprising facilitating, by the computing device, shipment of the purchased items.

3. The method of claim 2, wherein facilitating shipment of the purchased items comprises sending, by the computing device, an order to a distributor to have one or more of the purchased items shipped.

4. The method of claim 2, wherein facilitating shipment of the purchased items comprises, by the computing device, providing to the organization an indication of one or more specialized items that have been purchased for the organization to ship.

5. The method of claim 4, wherein providing to the organization an indication of one or more specialized items that have been purchased comprises providing, by the computing device, an interface where the organization can look up indications of specialized items which have been purchased.

6. The method of claim 4, wherein providing to the organization an indication of one or more specialized items that have been purchased comprises sending a notification of the one or more specialized items to the organization.

7. The method of claim 1, further comprising:
providing, by the computing device, a search interface;
receiving, by the computing device, a search query;
based on the search query, performing, by the computing device, a search through information about both the common stock items and the specialized items associated with the organization; and
providing, by the computing device, search results based on the performed search.

8. The method of claim 1, wherein determining portions of payments made for each of the purchased items to the organization comprises determining, by the computing device, a portion of shared revenue for each of the one or more displayed items.

9. The method of claim 8, wherein determining a portion of shared revenue for an item comprises determining the portion of shared revenue based at least in part on a determined profit margin for the item.

10. The method of claim 8, wherein determining a portion of shared revenue for an item comprises determining the portion of shared revenue based at least in part on whether the item is a common stock item or a specialized item.

11. The method of claim 1, wherein generating an online retail interface comprises generating the interface to appear similar to a website for the organization.

12. The method of claim 11, wherein generating the interface to appear similar to a website for the organization comprises:
receiving a request for the online retail interface from a user browsing the website for the organization, the website being served from a domain associated with the organization; and
generating and serving the interface as coming from the same domain associated with the organization.

13. A system for facilitating online retail sales, the system comprising:
one or more computer processors;
a specialized item storage coupled to the one or more computer processors and configured to store retail information about one or more specialized items which are associated with an organization;
a common stock storage coupled to the one or more computer processors and configured to store retail information about one or more common stock items;
a retail interface generation module configured, in response to execution by the one or more computer processors, to:
retrieve information relating to specialized items and common stock items from the specialized item storage and the common stock item storage;
generate a retail interface displaying one or more of the specialized items and common stock items for purchase by one or more users of the retail interface; and
facilitate purchases of one or more orders of items displayed in the retail interface; and
a revenue-sharing module configured, in response to execution by the one or more computer processors, to:
compute, for each purchased item, a portion of revenue received for the item to be shared with the organization; and
facilitate transmission of the computed portions of revenue to the organization.

14. The system of claim 13, further comprising a fulfillment module configured, in response to execution by the one or more computer processors, to facilitate shipment of one or more purchased specialized items to a purchaser.

15. The system of claim 14, wherein the fulfillment module is further configured to provide information to the organization identifying of one or more purchased specialized items for the organization to ship.

16. The system of claim 15, wherein the fulfillment module is further configured to send a notification to the organization identifying the one or more purchased specialized items for the organization to ship.

17. The system of claim 15, wherein the retail interface generation module is further configured to:
provide a search interface;
receive a search query;
based on the search query, perform a search through information about both the common stock items and the specialized items associated with the organization; and
provide search results based on the performed search.

18. One or more computer-readable media which, responsive to execution by a computing device, cause the device to perform operations for facilitating online retail sales, the operations including:
generating an online retail interface associated with an organization, the interface displaying items available for purchase, the displayed items comprising both specialized items associated with the organization and common stock items which may be displayed in interfaces associated with other organizations;
receiving an order to purchase one or more of the displayed items;
receiving payment for the one or more purchased items;
determining portions of revenue received for each of the purchased items to be shared with the organization, the portions of revenue including portions of revenue for common stock items as well as portions of revenue for specialized items; and
facilitating shipment of the purchased items.

19. The computer-readable media of claim 18, wherein the operations further include facilitating shipment of one or more purchased specialized items to a purchaser.

20. The computer-readable media of claim 18, wherein facilitating shipment of one or more purchased specialized items to a purchaser comprises providing one or more notifications, to the organization, one or more purchased specialized items for the organization to ship.

21. The computer-readable media of claim 18, wherein the operations further include:
providing a search interface;
receiving a search query;
based on the search query, performing a search through information about both the common stock items and the specialized items associated with the organization; and
providing search results based on the performed search.

22. The computer-readable media of claim 18, wherein determining portions of revenue received for each of the purchased items comprises determining the portion of shared revenue based at least in part on whether the item is a common stock item or a specialized item.
